(19) United States
(12) Patent Application Publication
(10) Pub. No.: US 2025/0366593 A1
(43) Pub. Date: Dec. 4, 2025

(54) COSMETIC APPLICATION DEVICE

(71) Applicant: Avi Berg, Niles, IL (US)

(72) Inventor: Avi Berg, Niles, IL (US)

(21) Appl. No.: 18/733,149

(22) Filed: Jun. 4, 2024

(51) Int. Cl. A45D 34/04; B25J 9/16; B25J 11/00

(52) U.S. Cl. CPC A45D 34/04; B25J 9/1697; B25J 11/008; A45D 2200/10

(57) ABSTRACT

A cosmetic application device for applying cosmetics to a user includes a robotic arm and a processor which is operatively coupled to the robotic arm. A cosmetic container is coupled to the robotic arm and is configured to hold a cosmetic substance. A dispensing tube is in fluid communication with the cosmetic container. The dispensing tube is mounted in the robotic arm and has an open end at a free end of the robotic arm. A pump is in fluid communication with the cosmetic container and the dispensing tube. The pump is operatively coupled to the processor and is configured to selectively urge the cosmetic substances from the cosmetic container and through the dispensing tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to automatic cosmetic application devices and more particularly pertains to a new automatic cosmetic application device for applying cosmetics to a user.

### (2) Description of Related Art Including Information Disclosed Under 37 CFR 1.97 and 1.98

The prior art relates to automatic cosmetic application devices. Some such devices use a robotic arm to apply makeup to a user. Others use a carriage which is movable with respect to the user via multiple rails. However, the prior art fails to describe such an apparatus which uses removable cartridges to contain cosmetic substances for application on the user and apparatuses which incorporate brushes or other applicator attachments with dispensing structures on a robotic arm.

### BRIEF SUMMARY OF THE INVENTION

An embodiment of the disclosure meets the needs presented above by generally comprising a robotic arm and a processor which is operatively coupled to the robotic arm. A cosmetic container is coupled to the robotic arm and is configured to hold a cosmetic substance. A dispensing tube is in fluid communication with the cosmetic container. The dispensing tube is mounted in the robotic arm and has an open end at a free end of the robotic arm. A pump is in fluid communication with the cosmetic container and the dispensing tube. The pump is operatively coupled to the processor and is configured to selectively urge the cosmetic substances from the cosmetic container and through the dispensing tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a detail in-use view of a cosmetic application device according to an embodiment of the disclosure.

FIG. 2 is a side view of an embodiment of the disclosure.

FIG. 3 is a front view of an embodiment of the disclosure.

FIG. 4 is a second side view of an embodiment of the disclosure.

FIG. 5 is a back view of an embodiment of the disclosure.

FIG. 6 is a top view of an embodiment of the disclosure.

FIG. 7 is a detail exploded view of an embodiment of the disclosure.

FIG. 8 is a block diagram of an embodiment of the disclosure.

### DETAILED DESCRIPTION OF THE INVENTION

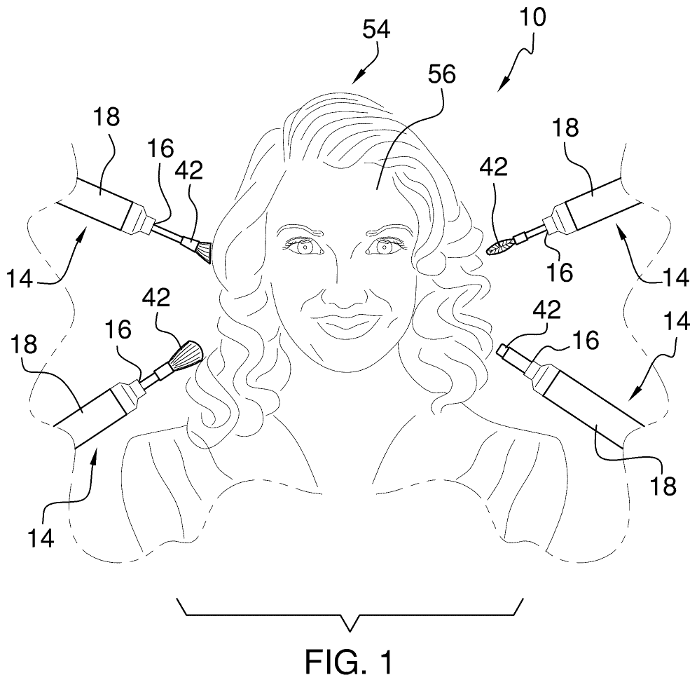

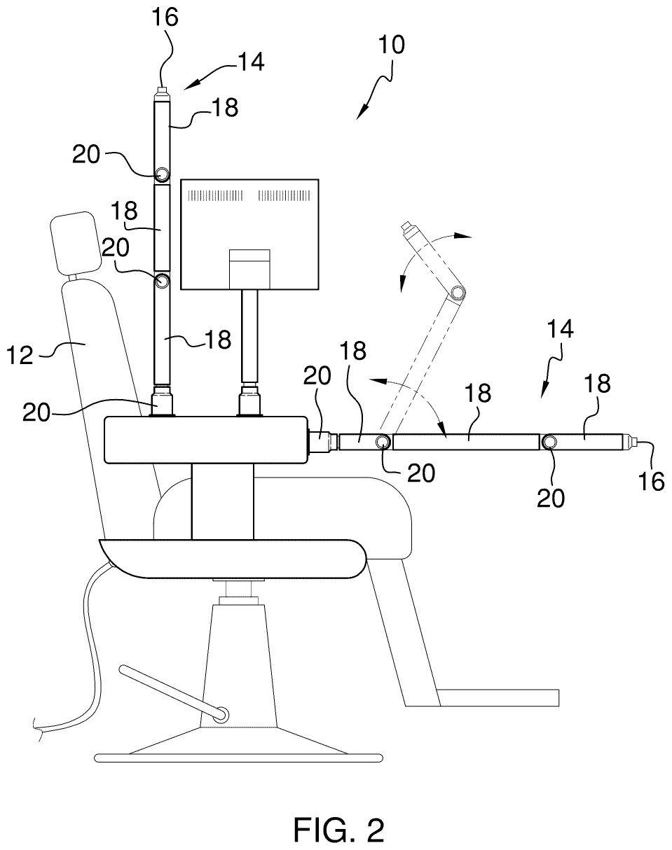

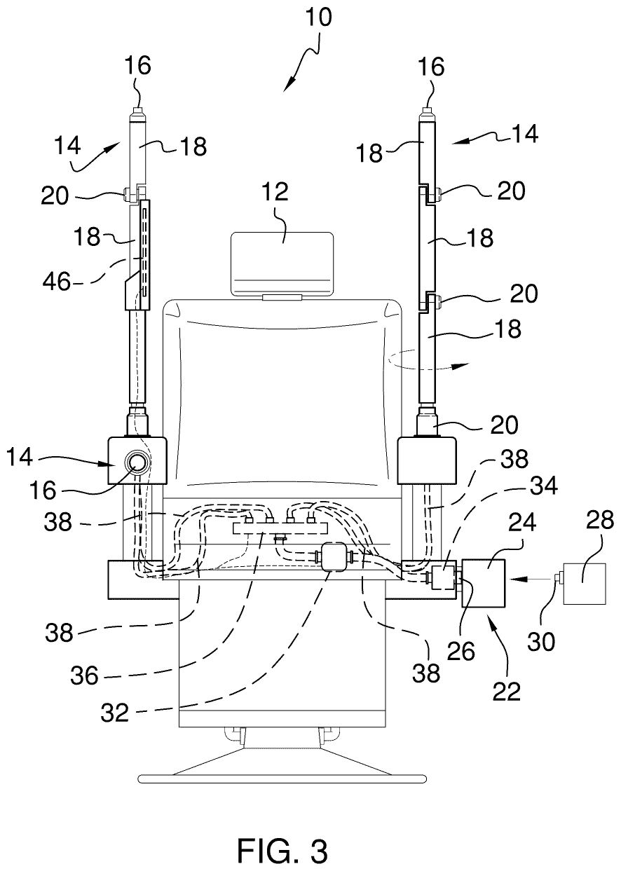

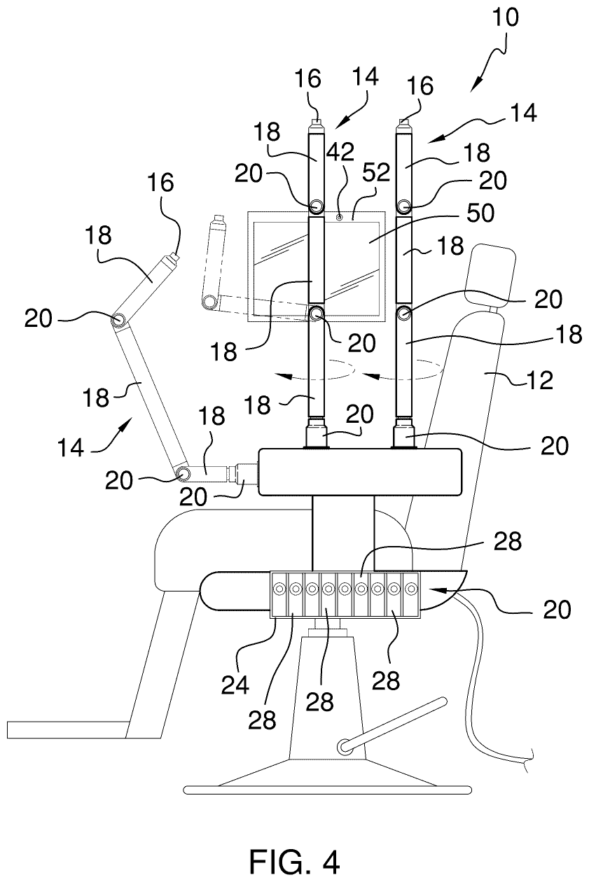

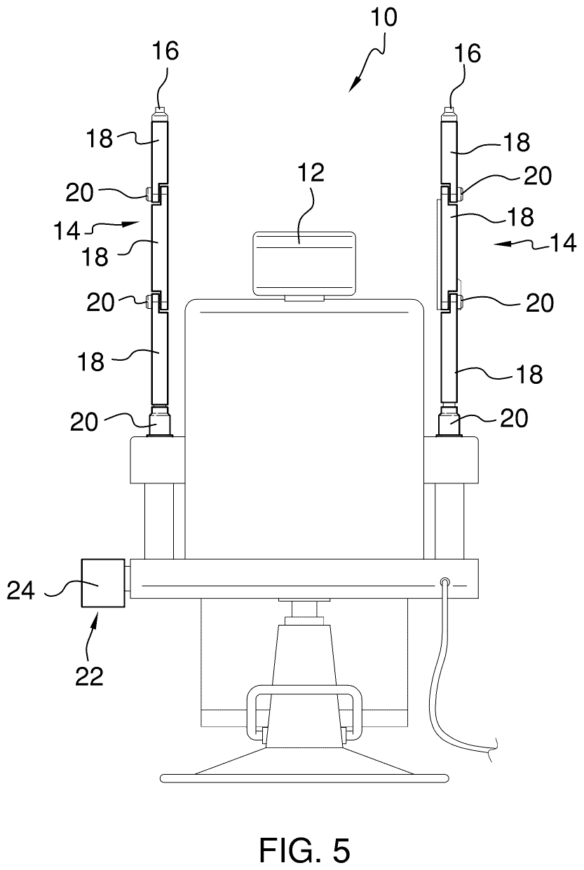

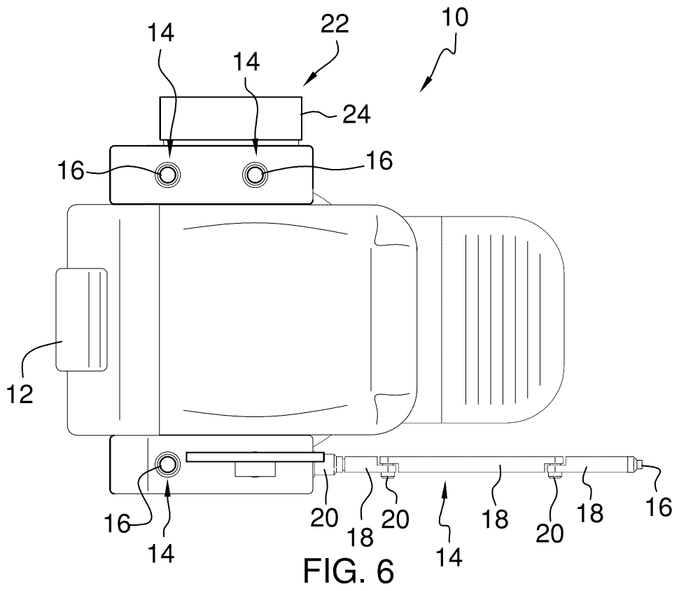

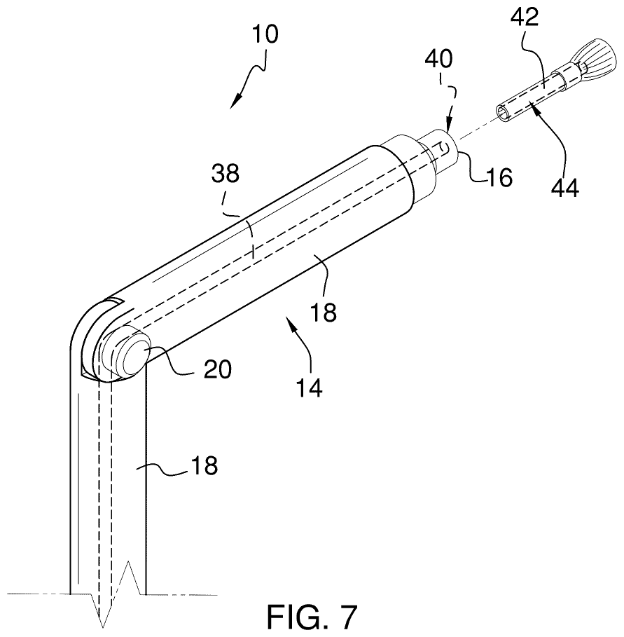

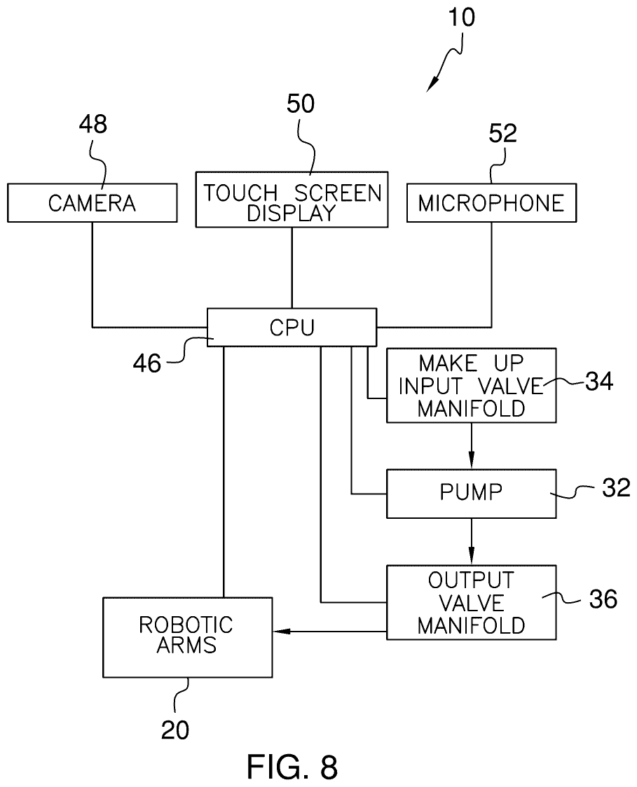

With reference now to the drawings, and in particular to FIGS. 1 through 8 thereof, a new automatic cosmetic application device embodying the principles and concepts of an embodiment of the disclosure and generally designated by the reference numeral 10 will be described.

As best illustrated in FIGS. 1 through 8, the cosmetic application device 10 generally comprises a chair 12 and a plurality of robotic arms 14 mounted to the chair 12. Each robotic arm 14 of the plurality of robotic arms 14 comprises a plurality of arm segments 18 and a plurality of drive members 20. The drive members 20 of each robotic arm 14 are configured to urge the arm segments 18 of the robotic arm 14 to move with respect to each other and the chair 12. The arm segments 18 of each robotic arm 14 are pivotably coupled to each other, and each drive member 20 of the plurality of drive members 20 of each robotic arm 14 comprises a motor. In other embodiments, at least some of the arm segments 18 may be slidable or otherwise movable with respect to each other, and the drive members 20 may include linear actuators, hydraulic actuators, or any other suitable actuator.

A cosmetic container 22 is mounted to the chair 12 and comprises a housing 24 and a plurality of cartridges 28 removably mountable in the housing 24. Each cartridge 28 of the plurality of cartridges 28 defines an interior space configured to contain an associated cosmetic substance of a plurality of cosmetic substances. Cosmetic substances may include any topical treatment such as lotions, makeup, or the like. Each cartridge 28 of the plurality of cartridges 28 defines an outlet 30 for facilitating the release of the associated cosmetic substance which inserts into an associated port 26 defined by the housing 24 when the cartridge 28 is mounted in the housing 24.

A pump 32 is in fluid communication with the ports 26 of the housing 24 of the cosmetic container 22 via an input valve manifold 34, and dispensing tubes 38 lead from the pump 32 to free ends 16 of associated robotic arms 14. The input valve manifold 34 is operable to selectively permit one or more of the cosmetic substances toward the pump 32, and the pump 32 is operable to urge the selected cosmetic substance through one or more dispensing tubes 38. Each dispensing tube 38 has an open end 40 at the free end 16 of the associated robotic arm 14. An output valve manifold 36 is in fluid communication with the pump 32 and the plurality of dispensing tubes 38 and is configured to selectively permit the cosmetic substances to move from the pump 32 to selected dispensing tubes 38.

Applicator attachments 42 are interchangeably attachable to the robotic arms 14 at the free ends 16 thereof by being received into openings defined by the robotic arms 14. In other embodiments, the applicator attachments 42 may attach via threaded fasteners, magnets, latches, or any other suitable fastening member. Each applicator attachment 42 of the applicator attachments 42 defines a channel 44 which extends therethrough. The channel 44 of each applicator attachment 42 is in fluid communication with an associated one of the plurality of dispensing tubes 38 when the applicator attachment 42 is attached to one of the robotic arms 14. Applicator attachments 42 may include brushes, mascara wands, pencils, markers, or the like. Some attachments in some embodiments may not define channels 44 for dispensing cosmetic substances. In some embodiments, atomizers or similar components may be included in some applicator attachments 42 or affixed to the robotic arms 14.

A processor 46 is operatively coupled to the robotic arms 14, the pump 32, the input valve manifold 34, and the output valve manifold 36. A camera 48 is operatively coupled to the processor 46, and the processor 46 has programming to determine locations of the free ends 16 of the robotic arms 14 with respect to a user 54 via images captured by the camera 48. The programming analyzes the images to identify the user's 54 face 56 or other body parts and the robotic arms 14, and determine the locations and distances of the free ends 16 of the robotic arms 14 with respect to the user 54. Cosmetics may be applied to the user's 54 face 56, fingernails, toenails, hair, or any other accessible body part.

A display 50 is operatively coupled to the processor 46 and includes a touch screen input for inputting instructions to the processor 46. The display 50 may present data such as selection options to input into the processor 46. A microphone 52 is also included for inputting audio inputs to the processor 46, which may be analyzed by the processor 46 to determine instructions for the processor 46. Other suitable input means also may be used. A card reader, slots and sensors for receiving and detecting cash payments, an application for receiving payment information, or the like may be incorporated such that individuals may pay for treatments performed by the cosmetic application device 10.

The camera 48 is mounted near the display 50 in the figures. In other embodiments, cameras, distance sensors, and the like may be mounted near the free ends 16 of the robotic arms 14 to enable the processor 46 to determine the positions and distances of the free ends 16 from the user 54, including particular facial features such as the user's 54 nose, cheek bones, and the like. Scanning devices or the like may be used to construct a three-dimensional model of the user 54 via the processor 46.

In use, the user 54 sits in the chair 12 and inputs commands to the processor 46 to direct the cosmetic application device 10 to apply the cosmetic substances as desired. The cartridges 28 of the cosmetic container 22 may be refilled or replaced and may be interchanged with other cartridges 28 containing other cosmetic substances. When actuated, the pump 32 urges one or more selected cosmetic substances from the cosmetic container 22 to the free end 16 of at least one of the robotic arms 14 to dispense onto an associated one of the applicator attachments 42 or directly onto the user 54. The robotic arms 14 may be operated to move one or more of the applicator attachments 42 in a manner to distribute cosmetics onto the user 54 or otherwise apply them as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cosmetic application device comprising:
a robotic arm;
a processor operatively coupled to the robotic arm;
a cosmetic container coupled to the robotic arm, the cosmetic container being configured to hold a cosmetic substance;
a dispensing tube in fluid communication with the cosmetic container, the dispensing tube being mounted in the robotic arm, the dispensing tube having an open end at a free end of the robotic arm;
a pump in fluid communication with the cosmetic container and the dispensing tube, the pump being operatively coupled to the processor, the pump being configured to selectively urge the cosmetic substances from the cosmetic container and through the dispensing tube.

2. The device of claim 1, further comprising a camera operatively coupled to the processor, the processor having programming to determine locations of the free ends of the robotic arms with respect to a user via images captured by the camera.

3. The device of claim 1, further comprising an applicator attachment attachable to the robotic arm at the free end thereof, the applicator attachment defining a channel which extends therethrough, the channel of the applicator attachment being in fluid communication with the dispensing tube when attached to the robotic arm.

4. The device of claim 1, further comprising a display operatively coupled to the processor.

5. The device of claim 4, wherein the display includes a touch screen input for inputting instructions to the processor.

6. The device of claim 1, further comprising a chair, the robotic arm being mounted to the chair, the robotic arm configured to apply the cosmetic substance to a user sitting in the chair.

7. The device of claim 1, wherein the robotic arm comprises a plurality of arm segments and a plurality of drive members, the drive members of the robotic arm being configured to urge the arm segments of the robotic arm to move with respect to each other.

8. The device of claim 7, wherein the arm segments of the robotic arm are pivotably coupled to each other, each drive member of the robotic arm comprising a motor.

9. The device of claim 1, wherein the cosmetic container is configured to hold a plurality of cosmetic substances, further comprising an input valve manifold in fluid communication with the cosmetic container and the pump, the input valve manifold being operatively coupled to the processor, the input valve manifold being configured to interchangeably permit selected ones of the cosmetic substances to move from the cosmetic container to the pump.

10. The device of claim 9, wherein the cosmetic container comprises a housing and a plurality of cartridges removably mountable in the housing, each cartridge of the plurality of cartridges defining an interior space configured to contain an associated cosmetic substance of the plurality of cosmetic substances, each cartridge of the plurality of cartridges defining an outlet for facilitating the release of the associated cosmetic substance.

11. The device of claim 1, wherein:
the robotic arm is one of a plurality of robotic arms;
the processor is operatively coupled to the plurality of robotic arms;
the dispensing tube is one of a plurality of dispensing tubes in fluid communication with the cosmetic container, each dispensing tube of the plurality of dispensing tubes being mounted in an associated robotic arm of the plurality of robotic arms, each dispensing tube of the plurality of dispensing tubes having an open end at a free end of the associated robotic arm; and
the cosmetic application device further comprises an output valve manifold in fluid communication with the pump and the plurality of dispensing tubes, the output valve manifold being operatively coupled to the processor, the output valve manifold being configured to selectively permit the cosmetic substances to move from the pump to a selected one of the plurality of dispensing tubes.

12. The device of claim 12, wherein the applicator attachment is one of a plurality of applicator attachments interchangeably attachable to the robotic arms at the free ends thereof, each applicator attachment of the plurality of applicator attachments defining a channel which extends therethrough, the channel of each applicator attachment being in fluid communication with an associated one of the plurality of dispensing tubes when attached to one of the robotic arms.

13. A cosmetic application device comprising:
a chair;
a plurality of robotic arms mounted to the chair, each robotic arm of the plurality of robotic arms comprising a plurality of arm segments and a plurality of drive members, the drive members of each robotic arm being configured to urge the arm segments of the robotic arm to move with respect to each other and the chair, the plurality of arm segments of each robotic arm being pivotably coupled to each other, each drive member of the plurality of drive members of each robotic arm comprising a motor;
a processor operatively coupled to the plurality of robotic arms;
a cosmetic container mounted to the chair and configured to hold a plurality of cosmetic substances, the cosmetic container comprising a housing and a plurality of cartridges removably mountable in the housing, each cartridge of the plurality of cartridges defining an interior space configured to contain an associated cosmetic substance of the plurality of cosmetic substances, each cartridge of the plurality of cartridges defining an outlet for facilitating the release of the associated cosmetic substance;
a plurality of dispensing tubes in fluid communication with the cosmetic container, each dispensing tube of the plurality of dispensing tubes being mounted in an associated robotic arm of the plurality of robotic arms, each dispensing tube of the plurality of dispensing tubes having an open end at a free end of the associated robotic arm;
a pump in fluid communication with the cosmetic container and the plurality of dispensing tubes, the pump being operatively coupled to the processor, the pump being configured to selectively urge the cosmetic substances from the cosmetic container and through the dispensing tubes;
an input valve manifold in fluid communication with the cosmetic container and the pump, the input valve manifold being operatively coupled to the processor, the input valve manifold being configured to interchangeably permit selected ones of the cosmetic substances to move from the cosmetic container to the pump;
an output valve manifold in fluid communication with the pump and the plurality of dispensing tubes, the output valve manifold being operatively coupled to the processor, the output valve manifold being configured to selectively permit the cosmetic substances to move from the pump to a selected one of the plurality of dispensing tubes;
a camera operatively coupled to the processor, the processor having programming to determine locations of the free ends of the robotic arms with respect to a user via images captured by the camera;
a plurality of applicator attachments interchangeably attachable to the robotic arms at the free ends thereof, each applicator attachment of the plurality of applicator attachments defining a channel which extends therethrough, the channel of each applicator attachment being in fluid communication with an associated one of the plurality of dispensing tubes when attached to one of the robotic arms; and
a display operatively coupled to the processor, the display including a touch screen input for inputting instructions to the processor.
